(19) United States
(12) Patent Application Publication
(10) Pub. No.: US 2025/0173747 A1
(43) Pub. Date: May 29, 2025

(54) CAFE MONITORING DEVICE AND CAFE MONITORING METHOD

(71) Applicant: MAZE INC., Hanam-si, Gyeong-gi-do (KR)

(72) Inventors: Ki Sun SONG, Hanam-si (KR); Kyung Min KO, Hanam-si (KR)

(73) Assignee: MAZE INC., Hanam-si, Gyeong-gi-do (KR)

(21) Appl. No.: 18/842,832

(22) PCT Filed: Mar. 2, 2023
(86) PCT No.: PCT/KR2023/002831

§ 371 Date: Aug. 30, 2024

(30) Foreign Application Priority Data
Mar. 24, 2022 (KR) 10-2022-0036960
Sep. 8, 2022 (KR) 10-2022-0114123

(51) Int. Cl. G06Q 30/0202; G06Q 30/0204; G06Q 50/12; G06T 7/70; G06V 20/52; G06V 40/10; G06V 40/16

(52) U.S. Cl. CPC G06Q 30/0202; G06Q 30/0204; G06Q 50/12; G06T 7/70; G06V 20/52; G06V 40/103; G06V 40/161; G06V 40/178

(57) ABSTRACT

A cafe monitoring device and a cafe monitoring method are provided. A cafe monitoring device includes: a camera configured to capture an internal space of the cafe and output captured data comprising images or videos; a first inference model configured to receive the captured data and output seat occupancy status data and customer appearance inference data for the cafe; and a second inference model configured to receive the captured data and output customer behavior inference data and menu sales estimation data for the cafe, wherein at least one of the seat occupancy status data, the customer appearance inference data, the customer behavior inference data, and the menu sales estimation data is used for cafe curation.

### TECHNICAL FIELD

Disclosed is a cafe monitoring device and a cafe monitoring method.

### BACKGROUND ART

Cafe curation services involve collecting and selecting information about various cafes, adding new value, and disseminating it. When a cafe owner who wants to attract customers registers their cafe with a cafe curation service, customers can receive recommendations for cafes that match their preferences or visit purposes through a user terminal. Notably, cafe curation services distinguish themselves from previous cafe recommendation services by offering cafes that align with values important to the user, rather than merely providing information about nearby cafes based on the user terminal's location or cafes with high review ratings. To implement a more valuable cafe curation service, research is being conducted on methods to collect information about the real-time status or predicted status inside cafes and utilize this information in the cafe curation service.

### Disclosure

### Technical Problem

The present disclosure addresses the need for a cafe monitoring device and a cafe monitoring method capable of monitoring the real-time status inside a cafe and predicting future status using AI (Artificial Intelligence) and IoT (Internet of Things)-based devices.

### Technical Solution

A cafe monitoring device according to an embodiment may include: a camera configured to capture an internal space of the cafe and output captured data comprising images or videos; a first inference model configured to receive the captured data and output seat occupancy status data and customer appearance inference data for the cafe; and a second inference model configured to receive the captured data and output customer behavior inference data and menu sales estimation data for the cafe, and at least one of the seat occupancy status data, the customer appearance inference data, the customer behavior inference data, and the menu sales estimation data may be used for cafe curation.

In some embodiments, the first inference model may include an object detection model, the seat occupancy status data may include at least one of a seat occupancy location, seat occupancy rate, entry time, and exit time of customers visiting the cafe, and the first inference model may infer at least one of the seat occupancy location, the seat occupancy rate, the entry time, and the exit time using the object detection model.

In some embodiments, the first inference model may infer the seat occupancy location by comparing a person bounding box with a seat bounding box.

In some embodiments, the cafe monitoring device may further include a seat determination module configured to determine the seat occupancy location based on whether a face or a back of a head is detected when a single person bounding box corresponds to multiple seat bounding boxes.

In some embodiments, the cafe monitoring device may further include a seat determination module configured to determine the seat occupancy location by comparing overlapping areas when a single person bounding box corresponds to multiple seat bounding boxes.

In some embodiments, the customer appearance inference data may include at least one of gender and age group of customers visiting the cafe, and the first inference model may infer at least one of the gender and the age group using the object detection model.

In some embodiments, the second inference model may include an object detection model and a pose estimation model, the customer behavior inference data may include at least one of visit purpose and behavior patterns of customers visiting the cafe, and the second inference model may detect an object using the object detection model, and if the detected object is a person, infer at least one of the visit purpose and the behavior patterns using the pose estimation model.

In some embodiments, the second inference model, if the detected object is an item and not a beverage or food, may infer at least one of the visit purpose and the behavior patterns using information related to the item and the pose estimation model.

In some embodiments, the menu sales estimation data may include at least one of ordered menu items and sales related to customers visiting the cafe, and the second inference model, if the detected object is an item and is a beverage or food, may infer at least one of the ordered menu items and sales using the object detection model.

In some embodiments, the cafe monitoring device may further include an inference data deletion module, and the first inference model may output a first inference completion signal including information related to first inference completion captured data among the captured data, the second inference model may output a second inference completion signal including information related to second inference completion captured data among the captured data, and the inference data deletion module may be configured to delete the first inference completion captured data in response to the first inference completion signal, and delete the second inference completion captured data in response to the second inference completion signal.

In some embodiments, the inference data deletion module may be configured to upon receiving the first inference completion signal, determine whether the first inference completion captured data is being used by the second inference model, and if it is determined that the first inference completion captured data is being used by the second inference model, retain the first inference completion captured data.

In some embodiments, the inference data deletion module may be configured to delete the second inference completion captured data upon receiving the second inference completion signal for the first inference completion captured data.

In some embodiments, the cafe monitoring device may further include an operation control module and a first load sensor, the operation control module may be configured to switch the cafe monitoring device to a first operation mode when a value of the first load sensor exceeds a first threshold, switch the cafe monitoring device to a second operation mode when the value of the first load sensor exceeds a second threshold, and switch the cafe monitoring device to a third operation mode when the value of the first load sensor is less than or equal to the first threshold.

In some embodiments, the cafe monitoring device may further include an operation control module and a first load sensor, the operation control module may be configured to when a value of the first load sensor exceeds a first threshold, perform a counting operation for a predetermined period, determine whether the value of the first load sensor exceeds a fourth threshold, and if it is determined that the value of the first load sensor exceeds the fourth threshold, switch the cafe monitoring device to a second operation mode.

In some embodiments, the operation control module may be configured to switch the cafe monitoring device to a third operation mode if it is determined that the value of the first load sensor is less than or equal to the fourth threshold.

A cafe monitoring method according to an embodiment may include: receiving captured data, including images or videos, obtained by capturing an internal space of a cafe; obtaining seat occupancy status data and customer appearance inference data for the cafe using the captured data and a first inference model; and obtaining customer behavior inference data and menu sales estimation data for the cafe using the captured data and a second inference model, and at least one of the seat occupancy status data, the customer appearance inference data, the customer behavior inference data, and the menu sales estimation data may be used for cafe curation.

In some embodiments, the first inference model may include an object detection model, the seat occupancy status data may include at least one of a seat occupancy location, seat occupancy rate, entry time, and exit time of customers visiting the cafe; and the first inference model may infer at least one of the seat occupancy location, the seat occupancy rate, the entry time, and the exit time using the object detection model.

In some embodiments, the customer appearance inference data may include at least one of gender and age group of customers visiting the cafe, and the first inference model may infer at least one of the gender and the age group using the object detection model.

In some embodiments, the second inference model may include an object detection model and a pose estimation model, the customer behavior inference data may include at least one of visit purpose and behavior patterns of customers visiting the cafe, and the second inference model may detect an object using the object detection model, and if the detected object is a person, infer at least one of the visit purpose and the behavior patterns using the pose estimation model.

In some embodiments, the menu sales estimation data may include at least one of ordered menu items and sales related to customers visiting the cafe, and the second inference model, if the detected object is an item and is a beverage or food, may infer at least one of the ordered menu items and sales using the object detection model.

### Advantageous Effects

According to the embodiments, the real-time status inside a cafe can be monitored and future status can be predicted using AI (Artificial Intelligence) and IoT (Internet of Things)-based devices.

### DESCRIPTION OF THE DRAWINGS

FIG. 1 is a block diagram illustrating a cafe curation system according to an embodiment.

FIG. 2 is a block diagram illustrating a cafe monitoring device according to an embodiment.

FIG. 3 is a flowchart illustrating a cafe monitoring method according to an embodiment.

FIG. 4 is a diagram illustrating the results of cafe monitoring according to an embodiment.

FIG. 5 is a flowchart illustrating a cafe monitoring method according to an embodiment.

FIGS. 6 and 7 are diagrams illustrating the results of cafe monitoring according to an embodiment.

FIG. 8 is a block diagram illustrating a cafe monitoring device according to an embodiment.

FIG. 9 is a flowchart illustrating a cafe monitoring method according to an embodiment.

FIG. 10 is a flowchart illustrating a cafe monitoring method according to an embodiment.

FIG. 11 is a block diagram illustrating a computing device according to an embodiment.

### MODE FOR INVENTION

Hereinafter, the embodiments of the present invention will be described in detail with reference to the accompanying drawings so that those skilled in the art to which the present invention pertains can easily implement them. However, the present invention is not limited to the embodiments described herein and may be implemented in various different forms. Moreover, in order to clearly describe the present invention in the drawings, parts irrelevant to the description have been omitted, and similar reference numerals have been used for similar parts throughout the specification.

In the entire specification and claims, when a part is described as “including” a certain component, it means that, unless specifically stated otherwise, the inclusion of other components is not excluded and that other components may be further included.

Furthermore, the terms such as “ . . . part,” “ . . . unit,” and “ . . . module” described in the specification may refer to units capable of processing at least one function or operation as described herein, and these units may be implemented as hardware, software, or a combination of hardware and software.

In this specification, the explanation is limited to cafes as the application target of the present invention for the sake of clarity. However, the scope of the present invention extends to cases where IoT devices are used to monitor the real-time status inside a store or space and to predict future status in any store or space, not just cafes.

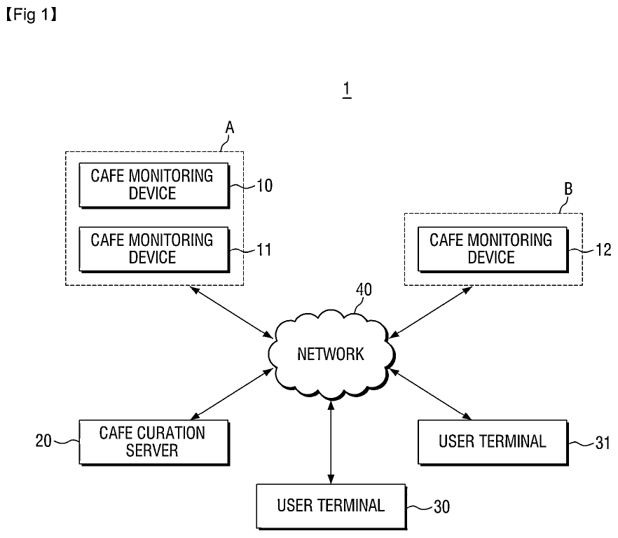

FIG. 1 is a block diagram illustrating a cafe curation system according to an embodiment.

Referring to FIG. 1, a cafe curation system 1 according to an embodiment may include cafe monitoring devices 10, 11, 12, a cafe curation server 20, and user terminals 30, 31. The cafe monitoring devices 10, 11, 12, the cafe curation server 20, and the user terminals 30, 31 may exchange data with each other through a network 40.

The cafe monitoring devices 10, 11, 12 may be IoT devices. IoT is a technology that embeds sensing and communication functions into objects, connecting them to the internet. The cafe monitoring devices 10, 11, 12 are installed inside cafes to monitor the internal space and may transmit the monitoring results to other devices, such as the cafe curation server 20, through the network 40. The cafe monitoring devices 10, 11, 12 are installed in various cafes to monitor the real-time status inside and predict future status. For example, the cafe monitoring devices 10 and 11 may be installed inside a cafe A to monitor and predict the status inside cafe A, while the cafe monitoring device 12 may be installed inside another cafe B to monitor and predict the status inside cafe B. The monitoring and prediction results obtained from the monitoring devices 10 and 11 installed in cafe A and the results obtained from the monitoring device 12 installed in cafe B may be transmitted to the cafe curation server 20 through the network 40.

The cafe curation server 20 may present cafes that align with the values considered important by the user (or customer) when selecting a cafe, based on the information collected about cafes A and B through the cafe monitoring devices 10, 11, 12, to the user via the user terminals 30, 31. The information collected through the cafe monitoring devices 10, 11, 12 may be stored and managed in a database accessible by the cafe curation server 20.

In some embodiments, certain information provided by the cafe monitoring devices 10, 11, 12 to the cafe curation server 20 (e.g., seating occupancy status data, customer appearance inference data, which will be described later) may be transmitted to the cafe curation server 20 in real-time. Specifically, the cafe monitoring devices 10, 11, 12 may transmit the said information to the cafe curation server 20 at a predetermined first time interval (e.g., 20 seconds). The predetermined time interval may be set differently depending on the specific implementation purpose and environment. Meanwhile, other information provided by the monitoring devices 10, 11, 12 to the cafe curation server 20 (e.g., customer behavior inference data, menu sales estimation data, which will be described later) may be transmitted to the cafe curation server 20 at a predetermined second time interval that is longer than the first time interval (e.g., several hours, several days). In this manner, information that needs to be frequently updated for the cafe curation server 20 to provide services is transmitted in real-time or at short time intervals, while information that does not require frequent updates is transmitted at relatively long time intervals. This allows for the efficient use of network bandwidth and reduces power consumption of the cafe monitoring devices 10, 11, 12.

In some embodiments, the cafe monitoring devices 10, 11, 12 may adjust the frequency of transmitting information to the cafe curation server 20, considering computing and network resources. For example, to use computing and network resources efficiently, the cafe monitoring devices 10, 11, 12 may average the monitoring and prediction results obtained at the first, second, and third time points and perform only one transmission to the cafe curation server 20.

In some embodiments, the cafe monitoring devices 10, 11, 12 may include a processor for monitoring and predicting the status inside the cafe based on artificial intelligence technology. However, since efficient operation of computing resources is often required in the environments where the cafe monitoring devices 10, 11, 12 are installed, the processor may be used in a sophisticated manner. Specifically, the cafe monitoring devices 10, 11, 12 may control the processor to use only the object detection function for some information provided to the cafe curation server 20, while for other information, they may control the processor to use both the object detection function and the pose estimation function. Additionally, for yet other information, the processor may be controlled to use both the object detection function and the semantic segmentation function. By mixing object detection, pose estimation, and semantic segmentation according to the characteristics of the information, the limited computing resources of the cafe monitoring devices 10, 11, 12 may be efficiently utilized.

The user terminals 30, 31 may connect to the cafe curation server 20 to receive cafe curation services based on the user's cafe selection preferences, the user's location, the user's movement patterns, order times, order menus, and the user's cafe usage history. In this way, the cafe curation service analyzes customer data and the status data obtained from inside the cafe through the cafe monitoring devices 10, 11, 12, allowing it to discover and recommend cafes that may genuinely satisfy the customer, rather than merely suggesting cafes that are nearby or well-known franchise cafes. In some embodiments, the user terminals 30, 31 may be computing devices such as smartphones, tablet computers, wearable devices, laptop computers, or desktop computers. The user may access the cafe curation service through an application running on the user terminals 30, 31.

The network 40 may include wireless networks such as Wi-Fi networks, Bluetooth networks, cellular networks, wired networks such as LAN (Local Area Network), and networks that are a combination of wireless and wired networks.

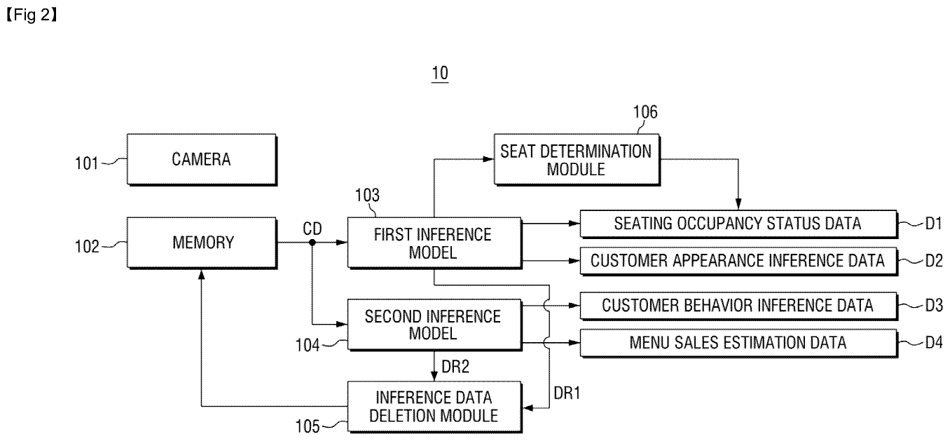

Hereinafter, a cafe monitoring device and cafe monitoring method according to embodiments will be described in detail with reference to FIGS. 2 to 10.

FIG. 2 is a block diagram illustrating a cafe monitoring device according to an embodiment.

Referring to FIG. 2, the cafe monitoring device 10 according to an embodiment may include a camera 101, a memory 102, a first inference model 103, and a second inference model 104. In the present specification, the description of the cafe monitoring device 10 may be equally applied to the cafe monitoring devices 11 and 12.

The camera 101 may capture the inside of the cafe and output captured data, including images or videos. In some embodiments, the camera 101 may include a PTZ (pan-tilt-zoom) camera, a fixed camera, or the like. Meanwhile, in some embodiments, the camera 101 may include an RGB camera, an IR camera, or similar types. To capture the inside of the cafe without blind spots, multiple cameras 101 may be installed in the cafe, and they may exchange data with each other through the network 40.

The memory 102 may load the software and data necessary for the operation of the cafe monitoring device 10. Specifically, the memory 102 may load program code for performing status monitoring and prediction of the inside of the cafe using the first inference model 103 or the second inference model 104, or it may load data used by the program code. Additionally, the memory 102 may load program code corresponding to firmware or an operating system that controls the overall operation of the cafe monitoring device 10.

The captured data output from the camera 101 is loaded into the memory 102, and the first inference model 103 and the second inference model 104 may access the captured data loaded in the memory 102 as camera data CD to perform status monitoring and prediction of the inside of the cafe.

The first inference model 103 may receive the captured data output from the camera 101 and may output seating occupancy status data D1 and customer appearance inference data D2 for the cafe. At least one of the seating occupancy status data D1 and the customer appearance inference data D2 may be used for cafe curation.

The seating occupancy status data D1 may include at least one of the occupied seat location, seating occupancy rate, entry time, and exit time of customers visiting the cafe. By way of non-limiting example, the occupied seat location may be represented by table numbers or seat numbers assigned to tables or seats inside the cafe. Additionally, by way of non-limiting example, the entry and exit times may be determined from multiple cafe monitoring devices installed inside the cafe. Specifically, when multiple cafe monitoring devices are installed inside the cafe, the time at which a visiting customer is recognized by one of the devices may be recorded as the customer's entry time, and the time at which the customer disappears from all of the devices may be recorded as the customer's exit time.

The first inference model 103 may include an object detection model. Here, the object detection model may extract features of the target object in advance and detect those features from the captured data. In some embodiments, pre-processing may be performed as necessary before feature extraction is carried out from the captured data. Then, detection by a classifier may be performed using the extracted features. In some embodiments, object detection may be carried out through various detection and recognition algorithms based on Convolutional Neural Networks (CNNs).

The first inference model 103 may utilize the object detection model to infer at least one of the occupied seat location, seating occupancy rate, entry time, and exit time of customers visiting the cafe. In this case, the object detection model may be configured to identify the target objects as people and seats from the captured data.

In some embodiments, the first inference model 103 may infer the occupied seat location by comparing the bounding box of a person with the bounding box of a seat. Specifically, the first inference model 103 may extract and classify the features of people and seats as target objects in advance, and then extract these features from the captured data or perform CNN-based detection and recognition, displaying the results as bounding boxes surrounding the detected people and seats. If the bounding box of a person and the bounding box of a seat overlap to the extent that they meet a predetermined criterion (e.g., approximately 90% of the area of the person's bounding box overlaps with the seat's bounding box), the first inference model 103 may determine that the person is occupying the seat. Alternatively, if the bounding box of a person and the bounding box of a seat overlap to a lesser extent that does not meet the predetermined criterion (e.g., only approximately 60% of the area of the person's bounding box overlaps with the seat's bounding box), the first inference model 103 may determine that the person is not occupying the seat. The predetermined criterion may be set differently for each seat, considering factors such as the shape of the seat and the angle from which the seat is viewed by the camera (e.g., the front or rear of the chair).

In some embodiments, the cafe monitoring device 10 may further include a seat determination module 106. The seat determination module 106 may determine the occupied seat location when a single person's bounding box corresponds to multiple seat bounding boxes, based on whether a face or the back of the head is detected. For example, if the bounding box of a person overlaps with two seats, including a front seat and a rear seat, face recognition or back-of-the-head recognition may be performed within the detected person's area. If face recognition within the detected person's area is successful, it may be determined that the person is occupying the front seat among the two seats. If face recognition fails or if back-of-the-head recognition is successful within the detected person's area, it may be determined that the person is occupying the rear seat.

In some embodiments, the seat determination module 106 may determine the occupied seat location by comparing the overlapping areas when a single person's bounding box corresponds to multiple seat bounding boxes. For example, approximately 30% of a person's bounding box area may overlap with the bounding box of one seat, while another approximately 60% of the person's bounding box area may overlap with the bounding box of the other seat. In such a case, it may be determined that the person is occupying the other seat.

The customer appearance inference data D2 may include at least one of the gender and age group of customers visiting the cafe. The customer appearance inference data D2 may be combined with the seating occupancy status data D1. For example, the occupied seat location from the seating occupancy status data D1 may be combined with the gender from the customer appearance inference data D2 to analyze which seats have a higher occupancy rate by gender. Additionally, the entry and exit times from the seating occupancy status data D1 may be combined with the age group from the customer appearance inference data D2 to analyze how long each age group stays during different time periods.

The first inference model 103 may utilize the object detection model to infer at least one of the gender and age group of customers visiting the cafe. In this case, the object detection model may be configured to identify the target objects from the captured data as people, belongings, clothing, shoes, and the like.

In some embodiments, the first inference model 103 may additionally perform semantic segmentation to create outlines of the recognized objects, thereby enabling element segmentation.

The second inference model 104 may receive the captured data output from the camera 101 and may output customer behavior inference data D3 and menu sales estimation data D4 for the cafe. At least one of the customer behavior inference data D3 and the menu sales estimation data D4 may be used for cafe curation.

The customer behavior inference data D3 may include at least one of the visit purpose and behavior patterns of customers visiting the cafe. By way of non-limiting example, visit purposes may include dining, resting, studying, reading, doing homework, or conversing. Additionally, by way of non-limiting example, behavior patterns may include using a smartphone, using a tablet computer, reading, typing, drawing, drinking a beverage, cutting food, or writing.

The second inference model 104 may include an object detection model and a pose estimation model. Here, pose estimation may refer to inferring the poses within the captured data. For example, it may include predicting the joint positions of a person in an image or video. In some embodiments, a deep neural network (DNN) that may capture the context of all joints, in addition to a graph-based model, may be used for pose estimation. In other words, when the second inference model 104 detects a person, it may output pivot points corresponding to the person's joints.

The second inference model 104 may detect objects using the object detection model, and if the detected object is a person, it may infer at least one of the visit purpose and behavior pattern using the pose estimation model. The visit purpose and behavior pattern may be inferred by identifying only the person, but they may also be inferred by identifying the objects that the person is using or carrying. In other words, the second inference model 104 may detect additional objects beyond just people using the object detection model, and if the detected object is something other than a beverage or food, it may use information about that object along with the pose estimation model to infer at least one of the visit purpose and behavior pattern. For example, if the identified object is a laptop computer and the person's pose is inferred to have their hands on the table, the behavior pattern may be inferred as typing and the visit purpose as document work. Alternatively, if the identified object is a laptop computer and the person's pose is inferred to have their hands lowered under the table, the behavior pattern may be inferred as watching a movie and the visit purpose as relaxation.

In some embodiments, when performing pose estimation for a person, a technique may be used that tracks by connecting only the pivot points of the upper body. Generally, pose estimation involves recognizing all joints of the entire body to analyze behavior patterns, but considering the characteristics of a cafe, where customers are mostly seated and primarily move their upper bodies, and to efficiently manage computing resources, the number of joints used in the inference calculation may be reduced by focusing only on the upper body when a person is detected.

The menu sales estimation data D4 may include at least one of the ordered menu items and sales information for customers visiting the cafe. By way of non-limiting example, the ordered menu items may include details such as whether the beverage is hot or cold, the size of the beverage, and the price of the beverage, while the sales information may include specific time-point sales, short-term sales patterns, and long-term sales patterns.

The second inference model 104 may infer at least one of the ordered menu items and sales information if the detected object is a beverage or food, using the object detection model. In this case, the object detection model may be configured to identify the target objects from the captured data as beverages, food, or similar items.

The seating occupancy status data D1, customer appearance inference data D2, customer behavior inference data D3, and menu sales estimation data D4 that may be obtained as described above may be output as text-type data. For example, the text-type data may be represented in a format such as “3 people at Table 1, 1 person at Table 3, 2 lattes, 3 iced Americanos, 3 females, 2 males.” The output text data may be abstracted into text data that follows a certain format, such as JSON, or it may be converted into encrypted text data. The monitoring device 10 may transmit this text-based data as the monitoring and prediction results to the cafe curation server 20.

It is important to note that the data transmitted from the monitoring device 10 to the cafe curation server 20 includes only anonymized text data, and no captured data that could potentially identify individuals is transmitted to the cafe curation server 20. This approach allows for the protection of personal information while still enabling the cafe's status to be understood and utilized as statistical data.

In some embodiments, the cafe monitoring device 10 may further include an inference data deletion module 105. The first inference model 103 may output a first inference completion signal DR1 that includes information related to the first inference completion captured data among the captured data, and the second inference model 104 may output a second inference completion signal DR2 that includes information related to the second inference completion captured data among the captured data. The inference data deletion module 105 may delete the first inference completion captured data based on the first inference completion signal DR1 and may delete the second inference completion captured data based on the second inference completion signal DR2.

Specifically, the first inference model 103 may output a first inference completion signal DR1, which includes information related to the captured data used for inferring the seating occupancy status data D1 and the customer appearance inference data D2, to the inference data deletion module 105. The inference data deletion module 105 may delete the captured data used for inferring the seating occupancy status data D1 and the customer appearance inference data D2 from the memory 102 and storage based on the first inference completion signal DR1. Additionally, the second inference model 104 may output a second inference completion signal DR2, which includes information related to the captured data used for inferring the customer behavior inference data D3 and the menu sales estimation data D4, to the inference data deletion module 105. The inference data deletion module 105 may delete the captured data used for inferring the customer behavior inference data D3 and the menu sales estimation data D4 from the memory 102 and storage based on the second inference completion signal DR2.

In some embodiments, when the inference data deletion module 105 receives the first inference completion signal DR1, it may determine whether the first inference completion captured data is still being used by the second inference model 104. If it is determined that the first inference completion captured data is being used by the second inference model 104, the inference data deletion module 105 may retain the first inference completion captured data without deleting it. In other words, this situation occurs when the first inference completion captured data is used not only by the first inference model 103 but also by the second inference model 104. Subsequently, when the inference data deletion module 105 receives the second inference completion signal DR2 for the first inference completion captured data, it may then delete the second inference completion captured data. This process ensures that the images and videos used for inference are safely deleted to protect personal information.

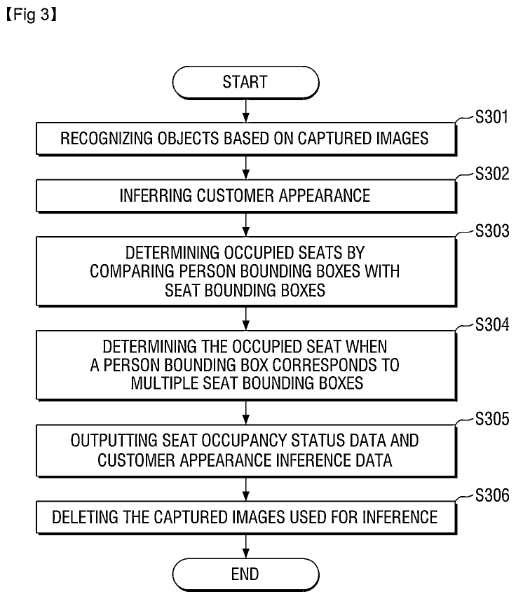

FIG. 3 is a flowchart illustrating a cafe monitoring method according to an embodiment.

Referring to FIG. 3, a cafe monitoring method according to an embodiment includes performing object recognition based on captured images in step S301 and inferring customer appearance in step S302. The method further includes comparing the bounding box of a person with the bounding box of a seat to determine the occupied seat in step S303, and in step S304, determining the occupied seat when the bounding box of a person corresponds to multiple seat bounding boxes. Additionally, the method includes outputting the seating occupancy status data D1 and customer appearance inference data D2 in step S305 and deleting the captured images used for inference in step S306.

For more detailed aspects of the cafe monitoring method according to an embodiment, reference can be made to the above descriptions related to FIGS. 1 and 2. Therefore, redundant explanations will be omitted here.

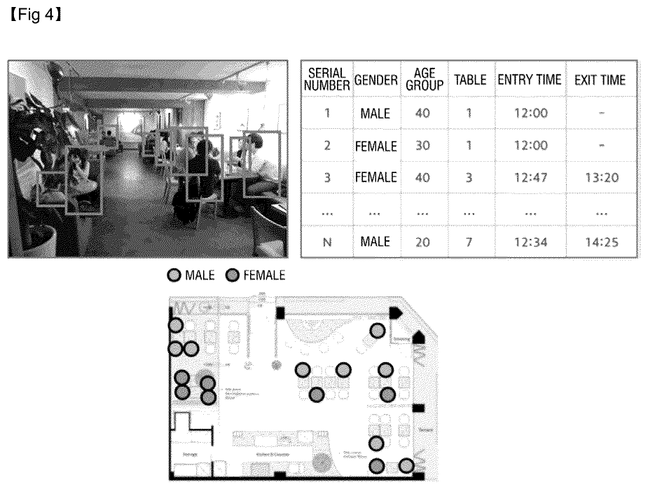

FIG. 4 is a diagram illustrating the results of cafe monitoring according to an embodiment.

Referring to FIG. 4, the first inference model 103 may receive the captured data output from the camera 101 and perform object detection to detect people. In this case, the first inference model 103 may analyze only the outline of the detected person's face without recognizing the face itself. This allows for identifying the seating location of an anonymous person to determine the seating occupancy status. Additionally, the first inference model 103 may perform object detection on features such as the detected person's hair length, clothing, hairstyle, footwear, and belongings to infer the customer's gender and age group.

From this, various analyses may be performed, such as analyzing the main demographic of cafe visitors, analyzing real-time or statistical seating occupancy, and analyzing the duration of stay at the cafe. For example, as illustrated, data such as gender, age group, occupied table, entry time, and exit time may be accumulated and analyzed. The cafe curation service may further analyze this customer data to discover and recommend cafes that may genuinely satisfy the customer, rather than simply suggesting cafes that are nearby or well-known franchise cafes.

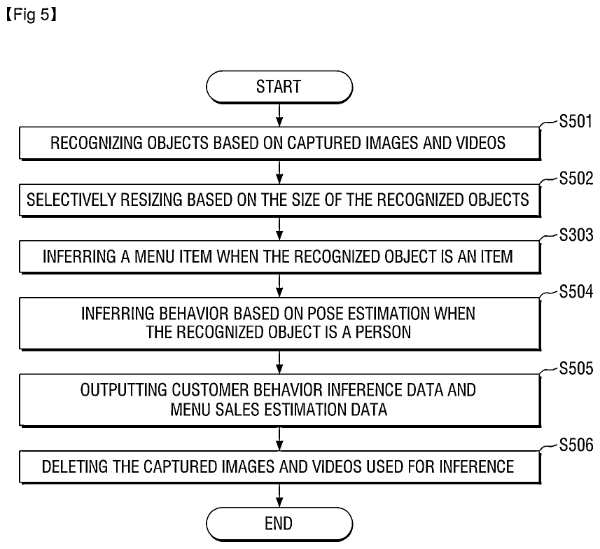

FIG. 5 is a flowchart illustrating a cafe monitoring method according to an embodiment.

Referring to FIG. 5, a cafe monitoring method according to an embodiment includes performing object recognition based on captured images and videos in step S501, and selectively resizing based on the size of the recognized object in step S502. Specifically, if the size of the recognized object is excessively small, selective resizing of the captured images and video frames may be performed. The method may include performing menu inference if the recognized object is a non-human item in step S503, and performing pose estimation-based behavior inference if the recognized object is a person in step S504. Additionally, the method includes outputting the customer behavior inference data D3 and menu sales estimation data D4 in step S505, and deleting the captured images and videos used for inference in step S506.

For more detailed aspects of the cafe monitoring method according to an embodiment, reference can be made to the above descriptions related to FIGS. 1 and 2. Therefore, redundant explanations will be omitted here.

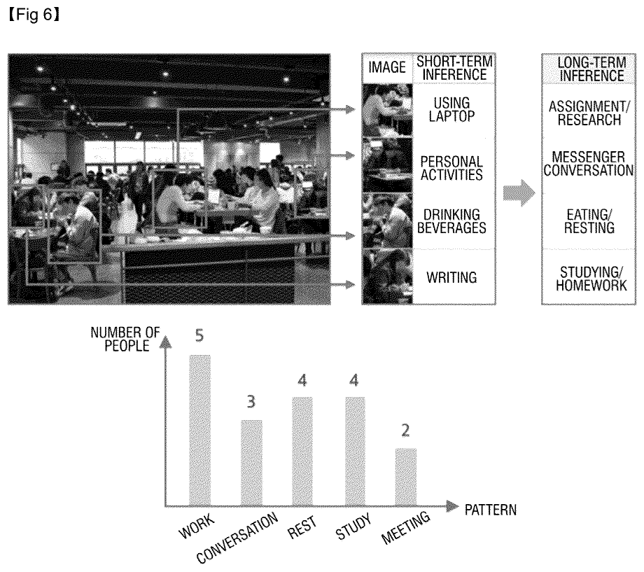

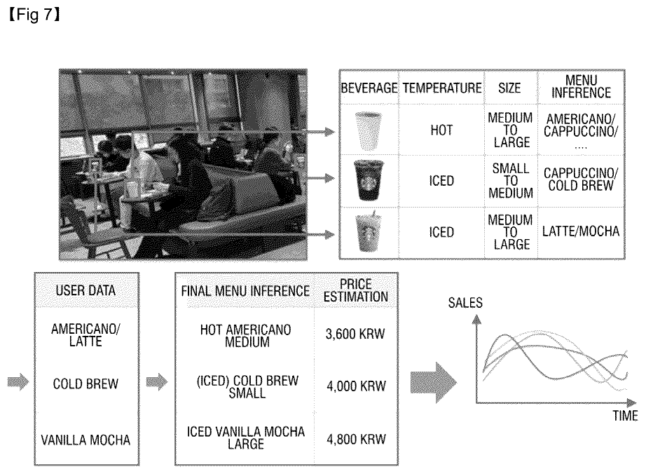

FIGS. 6 and 7 are diagrams illustrating the results of cafe monitoring according to an embodiment.

Referring to FIGS. 6 and 7, the second inference model 104 may receive the captured data output from the camera 101 and perform object detection and pose estimation to infer customer behavior. In this case, the second inference model 104 may set the pivot point range to the upper body only, rather than the entire body. As a result, the number of joints is reduced, and the variety of behavior patterns decreases, thereby reducing unnecessary computational load.

From this, various analyses may be performed, such as analyzing the main purposes for visiting the cafe, analyzing behavior statistics within the cafe that reflect the cafe's characteristics, and analyzing seating locations based on behavior patterns. For example, as shown in FIG. 6, short-term and long-term inferences may be made from pose estimation, allowing for the analysis of customer behavior within the cafe over time and linking the analysis results with seating occupancy rates. Additionally, analyses may be performed on real-time menu items and prices, overall menu orders, and sales. For example, as shown in FIG. 7, menu inference may be performed based on the temperature and size of the beverage, and by considering user data, the final menu items and prices may be estimated, allowing for the prediction of sales trends over time. The cafe curation service may further analyze customer data in conjunction with these analyses, enabling it to discover and recommend cafes that may genuinely satisfy the customer, rather than merely suggesting cafes that are nearby or well-known franchise cafes.

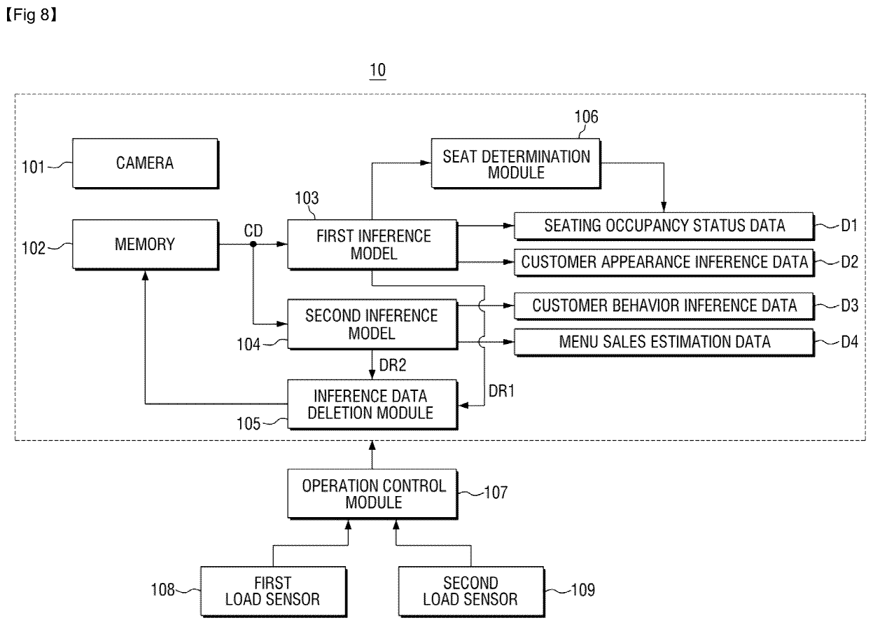

FIG. 8 is a block diagram illustrating a cafe monitoring device according to an embodiment.

Referring to FIG. 8, a cafe monitoring device 10 according to an embodiment may include not only a camera 101, a memory 102, a first inference model 103, a second inference model 104, an inference data deletion module 105, and a seat determination module 106, but also an operation control module 107 and load sensors 108 and 109.

The camera 101 may capture the inside of the cafe and output captured data, including images or videos. To capture the inside of the cafe without blind spots, multiple cameras 101 may be installed within the cafe, and these cameras 101 may exchange data with each other through the network 40.

The memory 102 may load the software and data necessary for the operation of the cafe monitoring device 10. Specifically, the memory 102 may load program code for performing status monitoring and prediction of the inside of the cafe using the first inference model 103 or the second inference model 104, or it may load the data used by that program code.

The captured data output from the camera 101 is loaded into the memory 102, and the first inference model 103 and the second inference model 104 may access the captured data loaded in the memory 102 as camera data CD to perform status monitoring and prediction of the inside of the cafe.

The first inference model 103 may receive the captured data output from the camera 101 and may output seating occupancy status data D1 and customer appearance inference data D2 for the cafe. At least one of the seating occupancy status data D1 and the customer appearance inference data D2 may be used for cafe curation.

The second inference model 104 may receive image data output from the camera 101 and may output customer behavior inference data D3 and menu sales estimation data D4 for the cafe. At least one of the customer behavior inference data D3 and menu sales estimation data D4 may be used for cafe curation.

The inference data deletion module 105 may delete the first inference completion captured data in response to the first inference completion signal DR1 and delete the second inference end captured data in response to the second inference end signal DR2.

As for the camera 101, memory 102, first inference model 103, second inference model 104, inference data deletion module 105, and seat determination module 106, reference can be made to the description provided in connection with FIG. 2, and therefore, redundant explanations will be omitted here.

The operation control module 107 may switch the operation mode of the cafe monitoring device 10 when the load on the cafe monitoring device 10 exceeds a predetermined threshold. Specifically, the operation control module 107 may switch the operation mode of the cafe monitoring device 10 among the first operation mode (an operation mode that halts operation for a predetermined period), the second operation mode (an operation mode that forcibly initiates a reboot), and the third operation mode (normal operation mode).

The first load sensor 108 may include, for example, a temperature sensor for measuring the temperature of the cafe monitoring device 10. In some embodiments, the operation control module 107 may switch the cafe monitoring device 10 to the first operation mode, which halts operation for a predetermined period, if the value of the first load sensor 108 exceeds the first threshold (e.g., 80 degrees). If the value of the first load sensor 108 exceeds the second threshold (e.g., 90 degrees), the operation control module 107 may switch the cafe monitoring device 10 to the second operation mode, which forcibly initiates a reboot. If the value of the first load sensor 108 returns to below the first threshold, the operation control module 107 may switch to the third operation mode, corresponding to normal operation mode.

Meanwhile, in some embodiments, the operation control module 107 may switch to the first operation mode if the value of the first load sensor 108 exceeds the first threshold (e.g., 80 degrees). After switching, it may perform a counting operation for a predetermined period and determine whether the value of the first load sensor 108 exceeds the fourth threshold (e.g., 90 degrees). If it is determined that the value of the first load sensor 108 exceeds the fourth threshold, meaning the temperature of the cafe monitoring device 10 has further increased during the counting period, the operation control module 107 may switch the cafe monitoring device 10 to the second operation mode. Alternatively, if it is determined that the value of the first load sensor 108 is below the fourth threshold, the operation control module 107 may switch the cafe monitoring device to the third operation mode.

Meanwhile, the second load sensor 109 may include, for example, a sensor for measuring the frame rate (fps) of the cafe monitoring device 10. In other words, the first load sensor 108 and the second load sensor 109 may consist of different types of sensors. The description provided for the first load sensor 108 may also apply to the second load sensor 109.

For example, in some embodiments, the operation control module 107 may switch the cafe monitoring device 10 to the first operation mode, which halts operation for a predetermined period, if the value of the second load sensor 109 exceeds the first threshold (e.g., when the frame rate drops below 20 fps). If the value of the second load sensor 109 exceeds the second threshold (e.g., when the frame rate drops below 10 fps), the operation control module 107 may switch the cafe monitoring device 10 to the second operation mode, which forcibly initiates a reboot. If the value of the first load sensor 108 returns to below the first threshold (e.g., when the frame rate rises above 20 fps), the operation control module 107 may switch to the third operation mode, corresponding to normal operation mode.

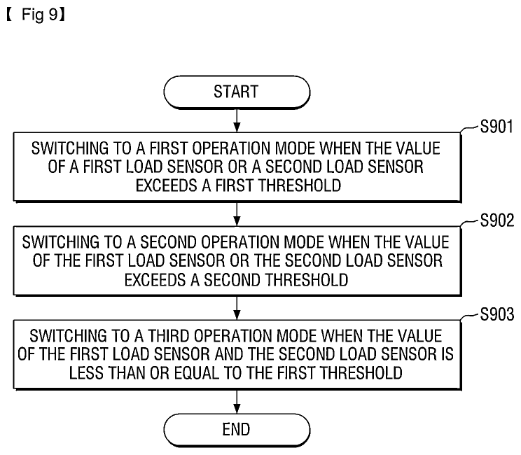

FIG. 9 is a flowchart illustrating a cafe monitoring method according to an embodiment.

Referring to FIG. 9, a cafe monitoring method according to one embodiment includes switching to the first operation mode in step S901 when the value of the first load sensor 108 or the second load sensor 109 exceeds the first threshold, switching to the second operation mode in step S902 when the value of the first load sensor 108 or the second load sensor 109 exceeds the second threshold, and switching to the third operation mode in step S903 when the value of the first load sensor 108 or the second load sensor 109 is below the first threshold.

For more detailed aspects of the cafe monitoring method according to an embodiment, reference can be made to the above descriptions related to FIG. 8. Therefore, redundant explanations will be omitted here.

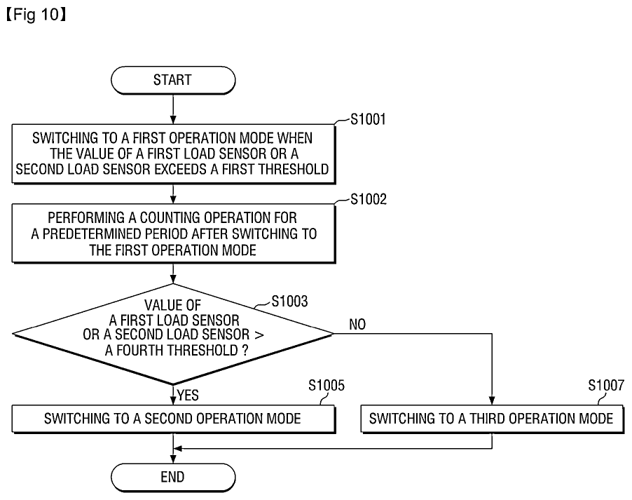

FIG. 10 is a flowchart illustrating a cafe monitoring method according to an embodiment.

Referring to FIG. 10, a cafe monitoring method according to one embodiment includes switching to the first operation mode in step S1001 when the value of the first load sensor 108 or the second load sensor 109 exceeds the first threshold, and performing a counting operation for a predetermined period after switching to the first operation mode in step S1002. The method then determines in step S1003 whether the value of the first load sensor 108 or the second load sensor 109 exceeds the fourth threshold, and if it does, proceeds to step S1004 to enter the second operation mode. Alternatively, if the value does not exceed the fourth threshold, the method proceeds to step S1005 to enter the third operation mode.

For more detailed aspects of the cafe monitoring method according to an embodiment, reference can be made to the above descriptions related to FIG. 8. Therefore, redundant explanations will be omitted here.

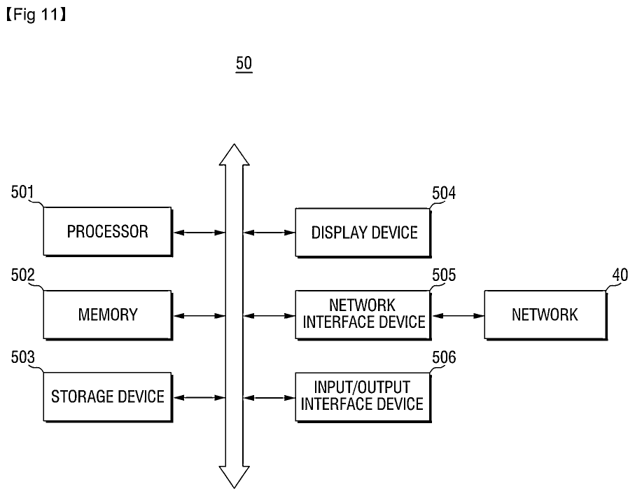

FIG. 11 is a block diagram illustrating a computing device according to an embodiment.

Referring to FIG. 11, the cafe monitoring device and cafe monitoring method according to the embodiments, as well as the cafe curation server and user terminals, may be implemented using a computing device 50.

The computing device 50 may include at least one of a processor 501, memory 502, storage device 503, display device 504, network interface device 505 providing access to a network 40 for communication with other entities, and an input/output interface device 506 that provides a user input interface or user output interface, all of which communicate via a bus 509. Of course, the computing device 50 may also include any additional electronic devices necessary to implement the technical concepts described in this specification, even though they are not depicted in FIG. 11.

The processor 501 may be implemented in various forms, such as an Application Processor (AP), Central Processing Unit (CPU), Graphic Processing Unit (GPU), or Neural Processing Unit (NPU), and may be any electronic device capable of executing programs or instructions stored in memory 502 or storage device 503. In particular, the processor 501 may be configured to implement the functions or methods described in connection with FIGS. 1 to 10. Additionally, computations related to artificial intelligence in the cafe monitoring device and cafe monitoring method according to the embodiments may be processed on the GPU or NPU.

The memory 502 and storage device 503 may include various types of volatile or non-volatile storage media. For example, memory 502 may include ROM (read-only memory) or RAM (random access memory) and may be located either internally or externally to the processor 501, and may be connected to the processor 501 through various means already known. Meanwhile, examples of the storage device 503 include HDD (Hard Disk Drive) or SSD (Solid State Drive), among others. The scope of the present invention is not limited to the elements listed above, which are provided for illustrative purposes.

At least a portion of the cafe monitoring device and cafe monitoring method according to the embodiments may be implemented as a program or software executed on the computing device 50. Such programs or software may be stored on a computer-readable medium.

Meanwhile, at least a portion of the cafe monitoring device and cafe monitoring method according to the embodiments may be implemented using the hardware of the computing device 50 or as separate hardware that may be electrically connected to the computing device 50.

The embodiments of the present invention have been described in detail above, but the scope of the present invention is not limited to these descriptions. Various modifications and improvements that utilize the basic concepts of the present invention, as defined in the following claims, and that are made by those skilled in the art to which the present invention pertains, are also within the scope of the present invention.

1. A cafe monitoring device, comprising:
a camera configured to capture an internal space of the cafe and output captured data comprising images or videos;
a first inference model configured to receive the captured data and output seat occupancy status data and customer appearance inference data for the cafe; and
a second inference model configured to receive the captured data and output customer behavior inference data and menu sales estimation data for the cafe,
wherein at least one of the seat occupancy status data, the customer appearance inference data, the customer behavior inference data, and the menu sales estimation data is used for cafe curation.

2. The cafe monitoring device according to claim 1, wherein:
the first inference model includes an object detection model;
the seat occupancy status data includes at least one of a seat occupancy location, seat occupancy rate, entry time, and exit time of customers visiting the cafe; and
the first inference model infers at least one of the seat occupancy location, the seat occupancy rate, the entry time, and the exit time using the object detection model.

3. The cafe monitoring device according to claim 2, wherein the first inference model infers the seat occupancy location by comparing a person bounding box with a seat bounding box.

4. The cafe monitoring device according to claim 3, further comprising:
a seat determination module configured to determine the seat occupancy location based on whether a face or a back of a head is detected when a single person bounding box corresponds to multiple seat bounding boxes.

5. The cafe monitoring device according to claim 3, further comprising:
a seat determination module configured to determine the seat occupancy location by comparing overlapping areas when a single person bounding box corresponds to multiple seat bounding boxes.

6. The cafe monitoring device according to claim 2, wherein:
the customer appearance inference data includes at least one of gender and age group of customers visiting the cafe; and
the first inference model infers at least one of the gender and the age group using the object detection model.

7. The cafe monitoring device according to claim 1, wherein:
the second inference model includes an object detection model and a pose estimation model;
the customer behavior inference data includes at least one of visit purpose and behavior patterns of customers visiting the cafe; and
the second inference model:
detects an object using the object detection model; and
if the detected object is a person, infers at least one of the visit purpose and the behavior patterns using the pose estimation model.

8. The cafe monitoring device according to claim 7, wherein the second inference model, if the detected object is an item and not a beverage or food, infers at least one of the visit purpose and the behavior patterns using information related to the item and the pose estimation model.

9. The cafe monitoring device according to claim 7, wherein:
the menu sales estimation data includes at least one of ordered menu items and sales related to customers visiting the cafe; and
the second inference model, if the detected object is an item and is a beverage or food, infers at least one of the ordered menu items and sales using the object detection model.

10. The cafe monitoring device according to claim 1, further comprising an inference data deletion module, wherein:
the first inference model outputs a first inference completion signal including information related to first inference completion captured data among the captured data;
the second inference model outputs a second inference completion signal including information related to second inference completion captured data among the captured data; and
the inference data deletion module is configured to:
delete the first inference completion captured data in response to the first inference completion signal; and
delete the second inference completion captured data in response to the second inference completion signal.

11. The cafe monitoring device according to claim 10, wherein the inference data deletion module is configured to:
upon receiving the first inference completion signal, determine whether the first inference completion captured data is being used by the second inference model; and
if it is determined that the first inference completion captured data is being used by the second inference model, retain the first inference completion captured data.

12. The cafe monitoring device according to claim 11, wherein the inference data deletion module is configured to delete the second inference completion captured data upon receiving the second inference completion signal for the first inference completion captured data.

13. The cafe monitoring device according to claim 1, further comprising an operation control module and a first load sensor, wherein the operation control module is configured to:
switch the cafe monitoring device to a first operation mode when a value of the first load sensor exceeds a first threshold;
switch the cafe monitoring device to a second operation mode when the value of the first load sensor exceeds a second threshold; and
switch the cafe monitoring device to a third operation mode when the value of the first load sensor is less than or equal to the first threshold.

14. The cafe monitoring device according to claim 1, further comprising an operation control module and a first load sensor, wherein the operation control module is configured to:
when a value of the first load sensor exceeds a first threshold, perform a counting operation for a predetermined period;
determine whether the value of the first load sensor exceeds a fourth threshold; and
if it is determined that the value of the first load sensor exceeds the fourth threshold, switch the cafe monitoring device to a second operation mode.

15. The device according to claim 14, wherein the operation control module is configured to switch the cafe monitoring device to a third operation mode if it is determined that the value of the first load sensor is less than or equal to the fourth threshold.

16. A cafe monitoring method, comprising:
receiving captured data, including images or videos, obtained by capturing an internal space of a cafe;
obtaining seat occupancy status data and customer appearance inference data for the cafe using the captured data and a first inference model; and
obtaining customer behavior inference data and menu sales estimation data for the cafe using the captured data and a second inference model, and
wherein at least one of the seat occupancy status data, the customer appearance inference data, the customer behavior inference data, and the menu sales estimation data is used for cafe curation.

17. The cafe monitoring method according to claim 16, wherein:
the first inference model includes an object detection model;
the seat occupancy status data includes at least one of a seat occupancy location, seat occupancy rate, entry time, and exit time of customers visiting the cafe; and
the first inference model infers at least one of the seat occupancy location, the seat occupancy rate, the entry time, and the exit time using the object detection model.

18. The cafe monitoring method according to claim 17, wherein:
the customer appearance inference data includes at least one of gender and age group of customers visiting the cafe; and
the first inference model infers at least one of the gender and the age group using the object detection model.

19. The cafe monitoring method according to claim 16, wherein:
the second inference model includes an object detection model and a pose estimation model;
the customer behavior inference data includes at least one of visit purpose and behavior patterns of customers visiting the cafe; and
the second inference model:
detects an object using the object detection model; and
if the detected object is a person, infers at least one of the visit purpose and the behavior patterns using the pose estimation model.

20. The cafe monitoring method according to claim 19, wherein:
the menu sales estimation data includes at least one of ordered menu items and sales related to customers visiting the cafe; and
the second inference model, if the detected object is an item and is a beverage or food, infers at least one of the ordered menu items and sales using the object detection model.
